(19) United States
(12) Patent Application Publication
(10) Pub. No.: US 2010/0211302 A1
(43) Pub. Date: Aug. 19, 2010

(54) Airspace Deconfliction System

(75) Inventors: James A. Ribbe, Brea, CA (US); Nasrin Azordegan, Yorba Linda, CA (US); John B. Morton, Diamond Bar, CA (US)

Correspondence Address: BAKER BOTTS LLP, 2001 ROSS AVENUE, 6TH FLOOR, DALLAS, TX, 75201-2980, US

(73) Assignee: Thales-Raytheon Systems Company LLC, Fullerton, CA (US)

(21) Appl. No.: 12/640,540

(22) Filed: Dec. 17, 2009

Related U.S. Application Data
(60) Provisional application No. 61/141,318, filed on Dec. 30, 2008.

(51) Int. Cl. G06F 19/00

(52) U.S. Cl. 701/120

(57) ABSTRACT

According to one embodiment, an airspace deconfliction system includes a deconfliction tool coupled to a data repository that stores records describing airspace objects, such as routes to be taken by an aircraft, airspace regions, and/or corridors. The deconfliction tool determines conflicts in the geographic location of the one airspace object with the geographic location of at least one of the other airspace objects.

### RELATED APPLICATIONS

This application claims priority to U.S. Provisional Patent Application Ser. No. 61/141,318, entitled “AIRSPACE DECONFLICTION SYSTEM,” which was filed on Dec. 30, 2008. U.S. Provisional Patent Application Ser. No. 61/141,318 is hereby incorporated by reference.

### TECHNICAL FIELD OF THE DISCLOSURE

This disclosure generally relates to aircraft maneuvers, and more particularly, to an airspace deconfliction system that determines conflicts among multiple objects that may affect the routes to be flown by aircraft.

### BACKGROUND OF THE DISCLOSURE

Military operations are often performed by multiple organizations that function together to achieve a common goal. For example, a country's army may coordinate its operations with its air force and/or its navy to conduct a military operation. Moreover, the country's army may segregated into multiple regiments that operate independently of one another. Military organizations such as these are often implemented due to their relatively efficient adaptability to ever changing conditions on the battlefield.

### SUMMARY OF THE DISCLOSURE

According to one embodiment, an airspace deconfliction system includes a deconfliction tool coupled to a data repository that stores records describing airspace objects, such as routes to be taken by an aircraft, airspace regions, and/or corridors. The deconfliction tool determines conflicts in the geographic location of the one airspace object with the geographic location of at least one of the other airspace objects.

Some embodiments of the disclosure may provide numerous technical advantages. For example, one embodiment of the airspace deconfliction system may provide enhanced coordination of multiple organizations operating in a confined airspace. Multiple organizations, such as the various military branches of a government, often conduct joint military operations. In many cases, decisions to occupy a particular region of the airspace occur frequently in response to changes on the battlefield. Certain embodiments of the airspace deconfliction system may provide a mechanism to share routes of aircraft and other airspace region information with cooperating organizations to avoid conflicts among multiple aircraft that may simultaneously occupy a portion of the region.

Some embodiments may benefit from some, none, or all of these advantages. Other technical advantages may be readily ascertained by one of ordinary skill in the art.

### BRIEF DESCRIPTION OF THE DRAWINGS

A more complete understanding of embodiments of the disclosure will be apparent from the detailed description taken in conjunction with the accompanying drawings in which:

FIG. 1 is an illustration showing one embodiment of an airspace deconfliction system according to the teachings of the present disclosure;

FIG. 2 is a diagram showing several elements of the airspace deconfliction system of FIG. 1;

FIG. 3 is an illustration showing how the airspace deconfliction system of FIG. 1 may determine a conflict between two routes to be taken by aircraft;

FIG. 4 is a flowchart showing one embodiment of a series of actions that may be performed by deconfliction tool of FIG. 1 to determine if any conflicts exist between two or more differing routes;

FIG. 5 is a flowchart showing a series of actions that may be performed by deconfliction tool of FIG. 1 to determine if any conflicts exist among two or more airspace regions;

FIG. 6 is a flowchart showing one embodiment of a series of actions that may be performed by deconfliction tool of FIG. 1 to determine the existence of any conflicts with a route and one or more airspace regions; and

FIG. 7 is a flowchart showing one embodiment of a series of actions that may be performed by deconfliction tool of FIG. 1 to determine conflicts of a route with a corridor.

### DETAILED DESCRIPTION OF EXAMPLE EMBODIMENTS

It should be understood at the outset that, although example implementations of embodiments are illustrated below, various embodiments may be implemented using any number of techniques, whether currently known or not. The present disclosure should in no way be limited to the example implementations, drawings, and techniques illustrated below. Additionally, the drawings are not necessarily drawn to scale.

Military operations often include the use of aircraft for various purposes, such as bombing of enemy sites and providing air cover for other military operations on the ground. Military operations including aircraft usually make use of flight plans. A flight plan generally describes the route to be taken by the aircraft and may include various operations to be performed while on the route, such as deployment of armament, support for other military operations, or conducting intelligence, reconnaissance, and surveillance (ISR) activities.

Numerous aircraft may conduct simultaneous missions over a particular region. In many cases, the routes taken by the aircraft are coordinated with one another to avoid intrusion into each other's airspace. In many cases, military operations are performed by multiple organizations that function together. For example, a country's army may have a fleet of helicopters or other low speed/altitude aircraft for support of their operations. The operations of aircraft such as these should be coordinated with aircraft from other organizations, such as the Navy or the Air Force to ensure one aircraft does not invade the airspace of aircraft of another organization.

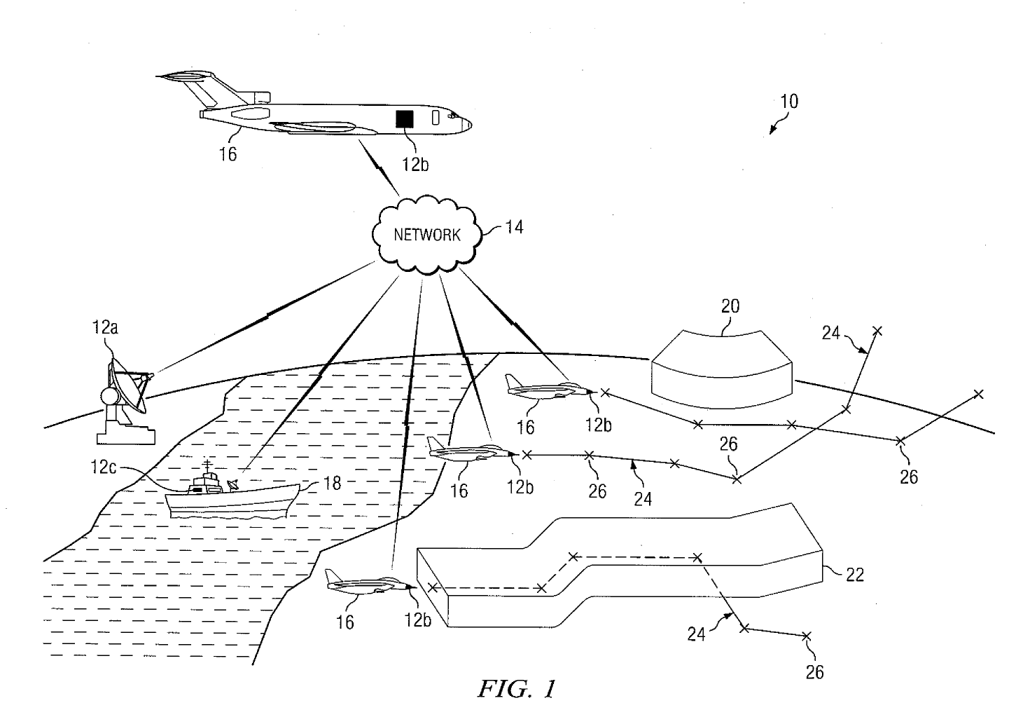

FIG. 1 is an illustration showing one embodiment of an airspace deconfliction system 10 according to the teachings of the present disclosure. Airspace deconfliction system 10 includes multiple nodes 12 that may be coupled together through a network 14. In the particular illustration shown, nodes 12 of airspace deconfliction system 10 include land-based nodes 12a configured on the ground, air-based nodes 12b configured on aircraft 16, and sea-based nodes 12c configured on sea-going vessels 18. In other embodiments, any configuration and quantity of nodes 12 may be implemented with airspace deconfliction system 10. As will be described in detail below, nodes 12 store information about airspace objects, such as airspace regions 20, corridors 22, and/or routes 24 from which airspace deconfliction system 10 manages future routes 24 to be taken by aircraft to avoid conflicts of the aircraft with each other and with various airspace regions 20 over a geographical region.

Routes 24 indicate a future path to be taken by an aircraft 16 and may each include multiple waypoints 26 indicating its anticipated position at a particular point in time. Routes 24 may also be referred to as flight plans. In some embodiments, waypoints 26 may be provided by latitude/longitude coordinates an may include altitude information that are referenced to a suitable geodetic coordinate frame, such as the world geodetic system (WGS) or North American Datum of 1983 (NAD83).

Airspace regions 20 may include any type or combination of multiple airspaces, such as special use airspaces (SUA), restricted airspaces, no-fly-zones, or prohibited airspaces that may affect the future route 24 of an aircraft 16. For example, an airspace region 20 may include a missile defense region in which military ground forces may be protecting a particular ground region with surface-to-air (SAM) missiles. As another example, airspace region 20 may be a civilian region that may include the airspace of a commercial airport or the region immediately above a neighborhood.

Corridors 22 are a particular type of airspace region that may be implemented for controlled movement of aircraft 16 from one location to another. As such, corridors 22 may include certain flight restrictions to ensure aircraft 16 do not conflict one another while in corridor 22. An aircraft 16 may enter into corridor 22 for a portion of its route 24, the entirety of its planned route 24, or may avoid entry into the corridor 22 altogether. For example, a corridor 22 may be established between an airport and a battlefield for coordinated passage of multiple aircraft 16 in a relatively safe and orderly manner. The corridor 22 may also have certain entry points and exit points that allow aircraft 16 to enter into and exit from the corridor 22 as part of their mission.

Network 14 may be any suitable type of communication medium such as a wireless network in which nodes 12 may transfer information to one another. For example, may be a packet data network, such as a public or private network, a local area network (LAN), a metropolitan area network, a wide area network (WAN), a wireline or wireless network, a global communication network, an optical network, a satellite network, an enterprise intranet, an intranet, a virtual private network (VPN), the Internet, or any combination of the preceding.

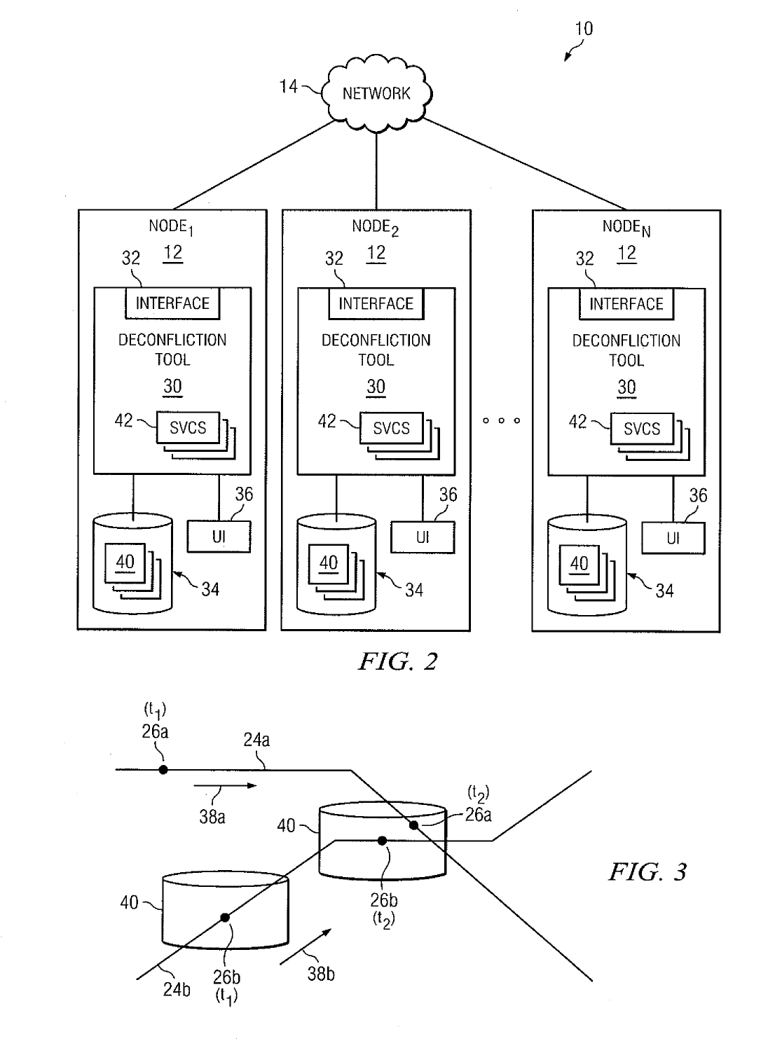

FIG. 2 is a diagram showing several elements of the airspace deconfliction system 10 of FIG. 1. Each node 12 includes a deconfliction tool 30 having an interface 32, a data repository 34, and a user interface 36 coupled as shown. Data repository 34 stores records 40 indicative of airspace objects, such as airspace regions 20, corridors 22, and/or routes 24.

The particular embodiment shown in which each of multiple nodes 12 are configured with deconfliction tool 30 may be useful for ad hoc scenarios in which aircraft may seek to enter or leave a region on a relatively frequent basis. Thus, deconfliction tool 30 may readily transfer records 40 stored in its memory with those of other aircraft 16 to coordinate their planned routes 24. In some embodiments, deconfliction tool 30 may be implemented on a single node 12 or a subset of nodes 12 of network 10. In this configuration, deconfliction may be performed by nodes 12 configured with deconfliction tool 30 and their resulting information shared with other nodes 12 that are not configured with deconfliction tool 30.

Deconfliction tool 30 includes executable code stored in a memory and executed by a processor of its respective node 12. Deconfliction tool 30 may be implemented using any suitable programming language or platform. In one embodiment, deconfliction tool 30 executes multiple services 42 operating in a service oriented architecture (SOA) that determines conflicts for future routes 24 that may be taken by aircraft 16.

Services 42 provide an interface 32 that for sharing its records 40 with other nodes 12 in airspace deconfliction system 10. Certain embodiments incorporating the use of services 42 operating in a service oriented architecture may provide an advantage in that a common interface may serve to reduce the effective variations in which information is managed and/or exposed by each participating node 12. For example, services 42 may be configured to expose all or only a portion of information associated with its stored records 40 with other nodes 12.

Services 42 each include an executable segment of code that provides a specified function. In some embodiments, the function provided by each service 42 has a level of granularity sufficient for management of a multi-level security system across multiple nodes 12. In one embodiment, services 42 may be administered through an enterprise service bus (ESB). The enterprise service bus orchestrates multiple services 42 together to provide one or more business applications, which in this particular application, is a deconfliction tool 30 for an airspace deconfliction system 10.

In one embodiment, airspace deconfliction tool 30 may be implemented on a geographical information system (GIS) that overlays routes 24 and airspace regions 20 on a geographical map displayed by user interface 36. In another embodiment, airspace deconfliction tool 30 may incorporate a Java topology suite (JTS) that maps routes and airspace regions 20 onto a geographically-based display platform.

User interface 36 may include a keyboard, a mouse, a console button, or other similar type of user input device for inputting user information to airspace deconfliction system 10. User interface 36 may also include a display, such as a cathode ray tube (CRT) or a liquid crystal display (LCD) for displaying information accessed by airspace deconfliction system 10.

Each node 12 may be may generally be adapted to execute any of the known OS2, UNIX, Mac-OS, Linux, and Windows Operating Systems or other operating systems. Each node 12 in this embodiment may include a processor, a memory, a user interface 36, and other devices such a communication link to communicate with other nodes 12. In other embodiments, a node 12 may include more, less, or other component parts.

Several embodiments may include logic contained within a medium. Logic may include hardware, software, and/or other logic. Logic may be encoded in one or more tangible media and may perform operations when executed by a computer. Certain logic, such as its processor, may manage the operation of its associated node 12. Examples of the processor may include one or more microprocessors, one or more applications, and/or other logic. Certain logic may include a computer program, software, computer executable instructions, and/or instructions capable being executed by the node 12. In particular embodiments, the operations of the embodiments may be performed by one or more computer readable media storing, embodied with, and/or encoded with a computer program and/or having a stored and/or an encoded computer program. The logic may also be embedded within any other suitable medium without departing from the scope of the invention.

The logic may be stored on a medium such as data repository 34 or other suitable memory. Data repository 34 may comprise one or more tangible, computer-readable, and/or computer-executable storage medium. Suitable examples may include computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), and/or other computer-readable medium.

Although the illustrated embodiment provides one embodiment of a node 12 that may be used with other embodiments, such other embodiments may additionally utilize computing systems other than general purpose computers as well as general purpose computers without conventional operating systems. Additionally, certain nodes 12 may also employ multiple computing systems networked together in a computer network. For example, a particular node 12 may include multiple computing systems that are networked together through an local area network (LAN) or an intranet. Embodiments may also be used with a combination of separate computer networks each linked together by a private or a public network.

FIG. 3 is an illustration showing how airspace deconfliction tool 30 may determine a conflict between two routes 24. In the particular illustration, route 24a represents a first aircraft 16 traveling in direction 38a and is assigned to be at waypoints 26a at specified times denoted by t₁ and t₂. Additionally, route 24b represents a second aircraft 16 traveling in direction 38b and is assigned to be at waypoints 26b at specified times denoted by t₁ and t₂. In the particular embodiment shown, airspace deconfliction tool 30 maps waypoints 26 to a buffer space 40 that in this embodiment, are three-dimensional cylinders. In other embodiments, airspace deconfliction tool 30 may map routes 24 to any suitable two-dimensional or three-dimensional object, such as a polygon, a circle, a parallelepiped, a cuboid, or a corridor. At time t₁, no conflict exists. However, at time t₂, a conflict exists wherein both buffer spaces 40 occupy the same space at the same future time. If deconfliction tool 30 determines this conflict, it may then transmit the detected conflict to user interface 36 for further inspection by a user of airspace deconfliction tool 30.

Conflict detection may be performed by airspace deconfliction tool 30 following the entry of each waypoint 26 or upon entry of the entire or a portion of the route 24 into user interface 36. For example, airspace deconfliction tool 30 may determine any potential conflicts in response to individually entered waypoints 26 through user interface 36. Conversely, airspace deconfliction tool 30 may determine any potential conflicts in response to a batch of waypoints 26 comprising a route 24 or a portion of a route 24 that are entered through user interface 36 simultaneously. Based upon this information, the user of airspace deconfliction tool 30 may modify the route 24 to avoid the determined conflict.

As used herein, “user” may generally refer to a person, entity, object, or device, capable of using deconfliction tool 30. For example, a user may be a person, accessing the deconfliction tool 30 through user interface 36. Alternatively, the user may be the computer, itself, programmed to access the deconfliction tool 30 automatically.

As an illustrative example, a user may access the deconfliction tool 30 through the Internet. Further details of example technologies that can be utilized in such access will be described below. The user may be a content seeker or a content provider. Content seekers generally seek to access or download digital content from the deconfliction tool 30 while content providers generally seek to ingest or upload digital content to deconfliction tool 30. In some embodiments, the user may access deconfliction tool 30 through a variety of other communication links including, but not limited to, a public or private data network; a local area network (LAN); a metropolitan area network (MAN); a wide area network (WAN); a wireline or wireless network; a local, regional, or global communication network; an optical network; a satellite network; an enterprise intranet; other suitable communication links; or any combination of the preceding.

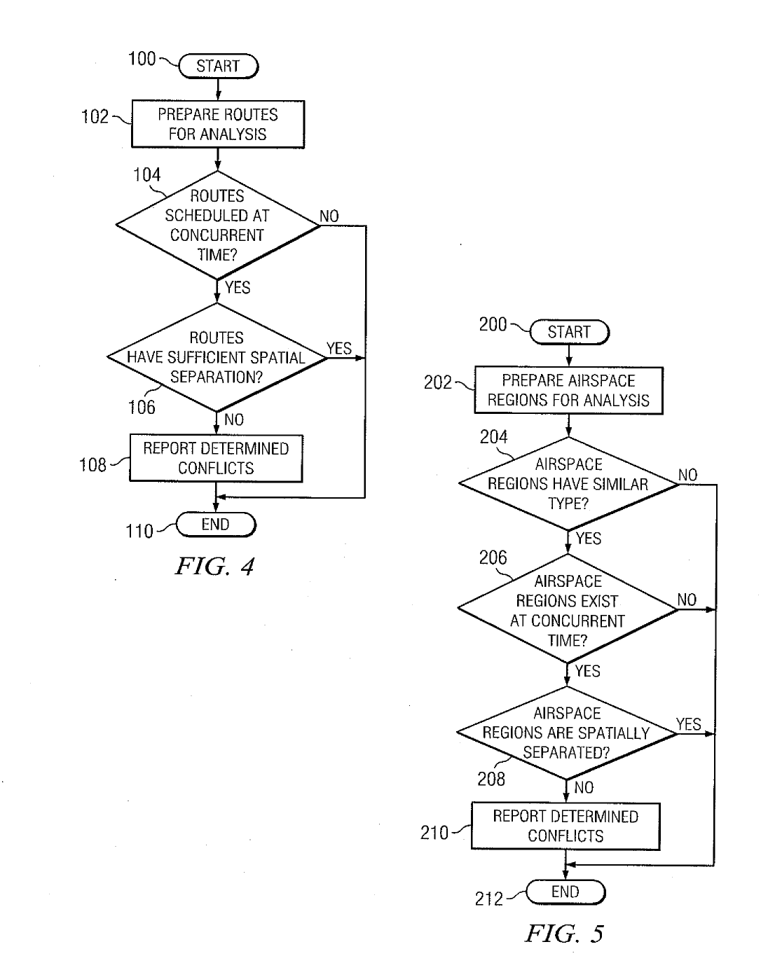

FIG. 4 is a flowchart showing one embodiment of a series of actions that may be performed by deconfliction tool 30 to determine if any conflicts exist between two or more differing routes 24. In act 100, the process is initiated.

In act 102, deconfliction tool 30 prepares routes 24 for analysis. Deconfliction tool 30 may prepare routes 24 according to any manner that facilitates confliction analysis using spatial analysis tools, such as a geographical information system (GIS) or other similar tool. In one embodiment, deconfliction tool 30 converts latitude/longitude coordinates of routes to Cartesian coordinates such that they may be suitable for use with a spatial analysis tool that uses the Euclidean coordinate system, such as the Java topology suite. In another embodiment, waypoints 26 of each route 24 may be mapped to a three-dimensional buffer space 40 having a volume that represents a buffer zone around its associated aircraft 16. Thus, deconfliction tool 30 may determine a conflict condition exists if the buffer space 40 of one waypoint 26 enters the buffer space 40 of another waypoint 26. The three-dimensional buffer space 40 may have any size and shape suitable for providing reasonably safe spatial separation of its associated aircraft 16 from other objects. For example, deconfliction tool 30 may map waypoints 26 to cylinders in which its circumference extends around the lateral extent of waypoint 26 and is bounded above and below according to the waypoint's 26 altitude. In other embodiments, deconfliction tool 30 may map routes 24 to any suitable two-dimensional or three-dimensional object, such as a polygon, a circle, a parallelepiped, or a cuboid.

In one embodiment, deconfliction tool 30 prepares routes 24 by adding additional waypoints 26 between existing waypoints 26 that have relatively long expanses between each other. For example, waypoints 26 are typically assigned to routes 24 at certain points to indicate a change of course or differing manner of operation assigned to its aircraft. Thus, legs between adjacent waypoints 26 may be relatively long for cases in which aircraft 16 has no change of direction for a relatively long period of time. In this case, deconfliction tool 30 may insert waypoints 26 along these legs to provide confliction analysis for relatively long legs of the route 24. In some cases, a leg of a route 24 may have a length great enough to be modeled using a great circle over the Earth's topology. In this particular case, deconfliction tool 30 may insert multiple waypoints 26 along this leg such that the great circle forms a polyline between the relatively distally located waypoints 26.

In act 104, deconfliction tool 30 compares the prepared routes 24 with one another according to the time in which they are to be conducted. If no concurrent routes 24 are detected, processing continues at act 110; otherwise, possessing continues at act 106.

In act 106, deconfliction tool 30 compares concurrent routes 24 with one another according to their spatial separation from one another. Deconfliction tool compares the location of each waypoint 26 of each route 24 with those of other routes 24 to determine whether a conflict exists. In a particular embodiment in which waypoints 26 have been mapped to three-dimensional buffer spaces 40, a confliction may be determined if the buffer space 40 of one waypoint 26 encroaches within the buffer space 40 of another waypoint 26. If no conflicts are detected, processing continues at act 110; otherwise, processing continues at act 108.

In act 108, deconfliction tool 30 reports any determined conflicts among multiple routes 24. In one embodiment, deconfliction tool 30 reports conflicts on user interface 36 by displaying the conflicting waypoints 26 along with their geographical location and time. Given this information, users of deconfliction tool 30 may be able to re-arrange routes 24 to remove conflicts determined by deconfliction tool 30.

The process described above may be continued for any and all routes 24 for which deconfliction is to be performed. When deconfliction analysis is no longer needed or desired, the process ends in act 110.

FIG. 5 is a flowchart showing a series of actions that may be performed by deconfliction tool 30 to determine if any conflicts exist among two or more airspace regions 20. Airspace regions 20 may have purposes that differs from one another according to their type. For example, some aircraft 16 may be prohibited from entering certain airspace regions 20 while being allowed into other airspace regions 20 under certain conditions. Thus, deconfliction of multiple airspace regions 20 may be performed to provide a geographical topology from deconfliction of aircraft 16 may be performed. In act 200, the process is initiated.

In act 202, deconfliction tool 30 prepares airspace regions 20 for analysis. Deconfliction tool 30 may prepare airspace regions 20 according to any manner that facilitates confliction analysis using spatial analysis tools such as those described above with reference to FIG. 4. In certain cases for example, those airspace region 20 that have been provided as generally two-dimensional shapes with only latitude and longitude coordinates may be extruded from its two-dimensional shape into a three-dimensional shape that include altitude information.

In act 204, deconfliction tool 30 compares the prepared airspace regions 20 with one another according to their type. For example, prohibited zones such as no-fly-zones may not conflict with one another, while a zone indicating a particular enemy's surface-to-air-missile (SAM) deployment site may conflict with another zone indicating a friendly airspace region 20 established for the purpose of helicopter support. Thus, deconfliction tool 30 may compare airspace regions 20 according to their type for determining any potential conflicts. If no conflicts are detected, processing continues at act 212; otherwise, processing continues at act 206.

In act 206, deconfliction tool 30 compares airspace regions 20 with one another according to their time of existence. In some cases, airspace regions 20 may be transient in nature. For example, a particular airspace region 20 may be temporally established for regulating the use of airspace during daylight hours. Thus, deconfliction tool 30 may compare this airspace region 20 with other airspace regions 20 only during daylight hours to determine if any potential conflicts exist. If no conflicts are detected, processing continues at act 212; otherwise, processing continues at act 208.

In act 208, deconfliction tool 30 compares airspace regions 20 with one another according to their spatial separation. Deconfliction tool 30 compares the volume of each airspace region 20 with others having a conflicting type. If no conflicts are detected, processing continues at act 212; otherwise, processing continues at act 210.

In act 210, deconfliction tool 30 reports any determined conflicts among the various airspace regions 20 in a manner similar as describe above with reference to act 108. In act 212, the process ends.

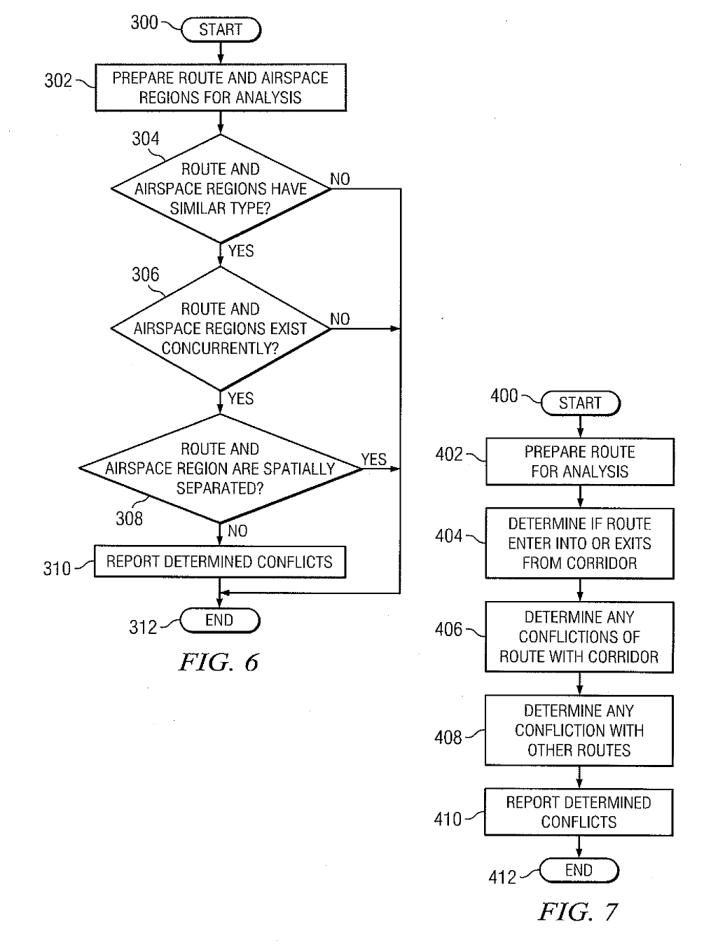

FIG. 6 is a flowchart showing one embodiment of a series of actions that may be performed by deconfliction tool 30 to determine the existence of any conflicts with a route 24 and one or more airspace regions 20. In act 300, the process is initiated.

In act 302, deconfliction tool 30 prepares the route 24 and one or more airspace regions 20 in a manner similar to that described with reference to acts 102 and 202, respectively.

In act 304, deconfliction tool 30 compares the route 24 with the airspace regions 20 according to their type. For example, the aircraft 16 associated with route 24 that is prohibited from entry into a particular airspace region 20 may be flagged as a conflict, while not flagged as a conflict if the aircraft 16 is not prohibited from entering into the airspace region 20. If no conflicts are detected, processing continues at act 312; otherwise, processing continues at act 306.

In act 306, deconfliction tool 30 compares the route 24 with airspace regions 20 to the airspace region's time of existence. If no conflicts are detected, processing continues at act 310; otherwise, processing continues at act 308.

In act 308, deconfliction tool 30 compares the route with airspace regions 20 according to their spatial separation from one another. In a particular embodiment in which waypoints 26 of route 24 have been mapped to three-dimensional buffer spaces 40, deconfliction tool 30 compares the volume of each three-dimensional buffer space 40 with the volume of each airspace region 20 to determine if they encroach one another. If no encroachment is determined, processing continues at act 310; otherwise, a confliction is determined and processing continues at act 310.

In act 310, deconfliction tool 30 reports any determined conflicts of the route 24 with the one or more airspace regions 20 in a manner similar as described above with reference to act 108. In act 312, the process ends.

FIG. 7 is a flowchart showing one embodiment of a series of actions that may be performed by deconfliction tool 30 to determine conflicts of a route 24 with a corridor 22. A corridor 22 comprises a special type of airspace in that aircraft 16 be enter and leave a corridor 22 based upon its adherence to certain conditions while in corridor 22. Thus, deconfliction tool may verify conformance of route 24 according to established guidelines of corridor 22. In act 400, the process is initiated.

In act 402, deconfliction tool 30 prepares the route 24 in a manner similar to that described with reference to act 102.

In act 404, deconfliction tool 30 determines for each leg of route 24, whether it enters into or leaves corridor 22. In one embodiment, deconfliction tool 30 determines entry into or exit from corridor 22 by sequentially comparing adjacent waypoints 26 of route 24 with corridor 22. That is, if one waypoint 26 is outside corridor 22 and the next adjacent waypoint 26 is within corridor 22, the route 24 is then determined to have entered corridor 22. Conversely, if one waypoint 26 is within corridor 22 and the next adjacent waypoint 26 is outside corridor 22, the route 24 is then determined to have left corridor 22.

In act 406, deconfliction tool 30 determines any conflicts of route 24 while in corridor 22. For example, deconfliction tool 30 may verify that the aircraft 16 is authorized to enter corridor 22, or that the aircraft 16 maintains proper airspeed while in corridor 22. As another example, deconfliction tool 30 may determine whether route 24 enters or leaves corridor 22 at properly established locations.

In act 408, deconfliction tool 30 performs route 24 to route 24 confliction processing to determine any potential conflicts with other aircraft 16 that may be in corridor 22 contemporaneously with each other. In one embodiment, route 24 to route 24 confliction processing may be performed according to the process as described with reference to the flowchart of FIG. 3.

In act 410, deconfliction tool 30 reports any determined conflicts of the route 24 with the corridor 22 in a manner similar as describe above with reference to act 108. In act 412, the process ends.

Each of the previously described processes of FIGS. 4 through 7 may be performed independently of one another or in conjunction with one another to determine conflicts. For example, conflicts among multiple airspace regions 20 may be determined according to the process of FIG. 5 to construct an airspace topology from which route 24 to airspace region 20 analysis may be performed using the process of FIG. 6. As another example, a portion of a particular route 24 may be analyzed for conflicts with other routes 24 using the process of FIG. 4, while another portion of the particular route 24 that exists in a corridor 22 may be analyzed according to the process of FIG. 7. In each case, conflicts determined by deconfliction tool 30 may be displayed in a manner such that routes 24 or certain airspace regions 20 may be modified, or eliminated to reduce potential conflicts of multiple aircraft 16 operating in a particular geographical location.

Modifications, additions, or omissions may be made to airspace deconfliction system 10 without departing from the scope of the disclosure. The components of airspace deconfliction system 10 may be integrated or separated. For example, each node 12 itself may include a network of multiple deconfliction tools 30 that communicate with one another and expose their objects for use by other nodes 12 through a single interface 32. Moreover, the operations of airspace deconfliction system 10 may be performed by more, fewer, or other components. For example, deconfliction tool 30 of one or more nodes may include interfaces to other sources of information, such as the Internet, for acquiring information associated with additional aircraft or other objects that may exist within the airspace of the one or more routes 24.

Although the present disclosure has been described with several embodiments, a myriad of changes, variations, alterations, transformations, and modifications may be suggested to one skilled in the art, and it is intended that the present disclosure encompass such changes, variations, alterations, transformation, and modifications as they fall within the scope of the appended claims.

What is claimed is:

1. An airspace deconfliction system comprising:
a deconfliction tool comprising a computer-readable media storing code executable by a computer processor of a computing system, the computing system coupled to a data repository storing a plurality of records that each describes an airspace object and a geographic location associated with the airspace object, the deconfliction tool operable to:
determine, for at least one record representing a future route to be taken by an aircraft, a conflict in the geographic location associated with the one record and the geographic location associated with at least one of the other records.

2. The airspace deconfliction system of claim 1, wherein the at least one record represents a route comprising a plurality of waypoints, the deconfliction tool operable to map each of the plurality of waypoints to a three-dimensional buffer space that is modeled in space and time.

3. The airspace deconfliction system of claim 1, wherein the plurality of records comprise a future time in which its associated airspace object exists, the deconfliction tool operable to:
determine for the at least one record, the conflict according to the future time of its associated airspace object and the future time associated with at least one of the other records.

4. The airspace deconfliction system of claim 1, wherein the code comprises a plurality of services operating in a service oriented architecture.

5. The airspace deconfliction system of claim 1, wherein the code comprises a Java topology suite (JTS) that is operable to map each airspace object associated with the plurality of records onto a geographically-based display platform.

6. The airspace deconfliction system of claim 1, wherein the deconfliction tool is coupled to a second data repository through an interface, the deconfliction tool operable to determine from among a plurality of second records stored in the second data repository, a second conflict in the geographic location of the one record and the geographic location of at least one of the second records.

7. The airspace deconfliction system of claim 1, wherein one of the plurality of other records represents another future route to be taken by another aircraft.

8. The airspace deconfliction system of claim 1, wherein one of the plurality of other records represents an airspace region.

9. The airspace deconfliction system of claim 1, wherein one of the plurality of other records represents a corridor.

10. An airspace deconfliction method comprising:
providing a data repository storing a plurality of records that each describes an airspace object and a geographic location associated with the airspace object; and
determining, for at least one record representing a future route to be taken by an aircraft, a conflict in the geographic location associated with the one record and the geographic location associated with at least one of the other records.

11. The method of claim 10, further comprising mapping each of a plurality of waypoints to a three-dimensional buffer space that is modeled in space and time, the plurality of waypoints comprising a route represented by the at least one record.

12. The method of claim 10, further comprising determining for the at least one record, the conflict according to the future time of the one record and the future time of the at least one other record, the plurality of records being associated with a future time in which its associated airspace object exists.

13. The method of claim 10, wherein determining the conflict in the geographic location of the one record and the geographic location of at least one of the other records is performed using a plurality of services operating in a service oriented architecture.

14. The method of claim 10, further comprising mapping each of the plurality of records onto a geographically-based display platform using a Java topology suite.

15. The method of claim 10, further comprising determining from among a plurality of second records stored in a second data repository, a second conflict in the geographic location associated with the one record and the geographic location associated with at least one of the second records.

16. The method of claim 10, wherein one of the plurality of other records represents another future mission to be taken by another aircraft.

17. The method of claim 10, wherein one of the plurality of other records represents an airspace region.

18. The method of claim 10, wherein one of the plurality of other records represents a corridor.

19. Code implemented on a computer-readable medium, when executed by a computer, operable to perform at least the following:
access a data repository storing a plurality of records that each describes an airspace object and a geographic location associated with the airspace object; and
determine, for at least one record representing a future route to be taken by an aircraft, a conflict in the geographic location associated with the one object and the geographic location associated with at least one of the other records.

20. The code of claim 19, further operable to map each of a plurality of waypoints to a three-dimensional buffer space that is modeled in space and time, the plurality of waypoints comprising a route represented by the at least one record.

21. The code of claim 19, further operable to determine for the at least one record, the conflict according to the future time associated with the one record and the future time associated with at least one other record, the plurality of records associated with a future time in which its associated airspace object exists.

22. The code of claim 19, wherein determining the conflict in the geographic location of the one record and the geographic location associated with at least one of the other records is performed using a plurality of services operating in a service oriented architecture.

23. The code of claim 19, further operable to map the plurality of records onto a geographically-based display platform using a Java topology suite.

24. The code of claim 19, further operable to determine from among a plurality of second records stored in a second data repository, a second conflict in the geographic location of the one record and the geographic location of at least one of the second records.

25. The code of claim 19, wherein one of the plurality of other records represents another future mission to be taken by another aircraft.

26. The code of claim 19, wherein one of the plurality of other records represents an airspace region.

27. The code of claim 19, wherein one of the plurality of other records represents a corridor.
